(19) United States
(12) Patent Application Publication
(10) Pub. No.: US 2022/0400714 A1
(43) Pub. Date: Dec. 22, 2022

(54) TOFU PUDDING MADE WITH FRUIT JUICE

(71) Applicant: Haifeng Situ, Fresno, CA (US)

(72) Inventor: Haifeng Situ, Fresno, CA (US)

(21) Appl. No.: 17/353,814

(22) Filed: Jun. 22, 2021

(51) Int. Cl. A23L 9/10; A23L 33/185; A23L 3/16; A23L 33/125

(52) U.S. Cl. CPC A23L 9/12; A23L 33/185; A23L 3/16; A23L 33/125

(57) ABSTRACT

Some embodiments of the present disclosure include a fruit flavored tofu pudding made with fruit juice and a method of making the same. In some embodiments, the method may include mixing water, sugar, coagulants, a pH buffer agent, fruit juice, and optional natural flavorings and colorings in a preliminary mixture; adding an appropriate amount of the pH buffer agent to have a pH of the preliminary mixture be slightly above the isoelectric point of soy protein; adding soymilk to the preliminary mixture after a desired pH has been attained, creating a mixture; and coagulating and pasteurizing the mixture, resulting in a fruit flavored tofu pudding having a smooth and elastic texture.

### BACKGROUND

The embodiments described herein relate generally to food, and more particularly, to a fruit flavored tofu pudding made with fruit juice.

Traditional tofu pudding is made from a combination of soymilk, sugar, coagulants, and optional flavoring. Conventional fruit flavored tofu pudding is made using the addition of starch or jelly, neither of which results with the smooth and elastic texture of traditional tofu pudding. The addition of fruit juice to traditional tofu pudding results in uncontrollable coagulation, resulting in the pudding not having a smooth texture.

Therefore, what is needed is a fruit flavored tofu pudding made from fruit juice that is smooth like traditional tofu pudding and a method of making the same.

### SUMMARY

Some embodiments of the present disclosure include a fruit flavored tofu pudding made with fruit juice and a method of making the same. In some embodiments, the method may include mixing water, sugar, coagulants, a pH buffer agent, fruit juice, and optional natural flavorings and colorings in a preliminary mixture; adding an appropriate amount of the pH buffer agent to have a pH of the preliminary mixture be slightly above an isoelectric point of soy protein; adding soymilk to the preliminary mixture after a desired pH has been attained, creating a mixture; and coagulating and pasteurizing the mixture by heating the mixture to a predetermined temperature, resulting in a fruit flavored tofu pudding having a smooth and elastic texture.

### BRIEF DESCRIPTION OF THE FIGURES

Having thus described the invention in general terms, reference is now made to the accompanying FIGURES, which show different views of different example embodiments.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The method of the present disclosure may be used to make tofu pudding using fruit juice while maintaining the smooth texture of traditional tofu pudding and may be comprised of the following elements. This list of possible constituent elements is intended to be exemplary only, and it is not intended that this list be used to limit the method and pudding of the present application to just these elements. Persons having ordinary skill in the art relevant to the present disclosure may understand there to be equivalent elements that may be substituted within the present disclosure without changing the essential function or operation of the device.

1. Fruit Juice

2. PH Buffer Agent

3. Water

4. Coagulants

5. Soymilk

The various elements of the method and pudding of the present invention may be related in the following exemplary fashion. It is not intended to limit the scope or nature of the relationships between the various elements and the following examples are presented as illustrative examples only.

By way of example, and referring to FIGURE, some embodiments of the invention include a tofu pudding made with fruit juice and a method of making the same. In embodiments, the pudding of the present disclosure comprises a mixture of fruit juice, a pH buffer agent, such as sodium citric, water, traditional coagulants, such as calcium sulfate and glucono delta-lactone (GDL), and soymilk, the combination resulting in a smooth, fruit flavored tofu pudding.

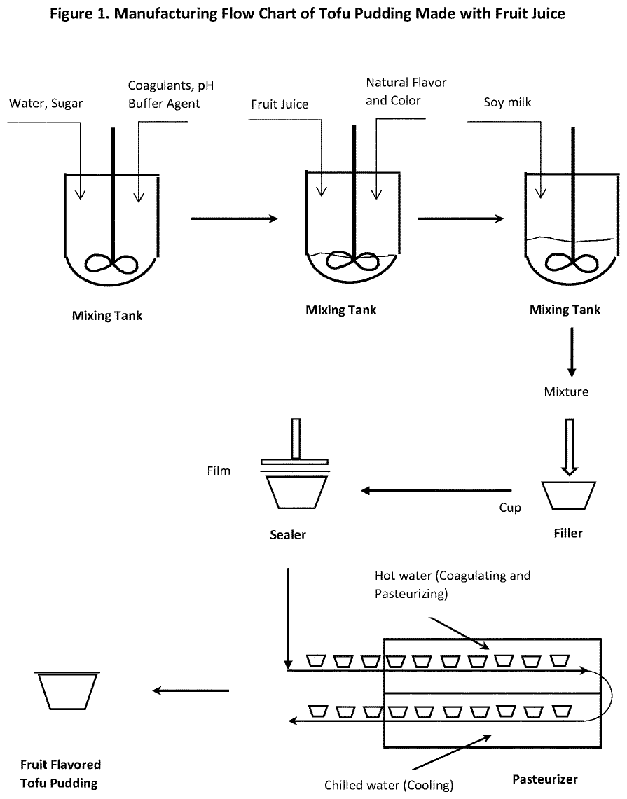

As shown in FIG. 1, methods of making the pudding of the present disclosure may comprise adding water, sugar, coagulants, and a pH buffer agent to a mixing tank; then add fruit juice and other natural flavors and colors to the mixing tank, wherein the pH of the fruit juice may be adjusted by adding additional pH buffer agent, such that the pH of the mixture is somewhat above the isoelectric points of soy protein, such as from about 5.0 to about 5.5, to prevent coagulation when soymilk is added; and adding soymilk to the mixing tank, creating a mixture. After the mixture has been mixed well, the mixture may be transferred into a cup and sealed, wherein the sealed cup may be heated to above its coagulation point to form the smooth and elastic tofu pudding. For example, the sealed cup may be coagulated and pasteurized with hot water and then cooled with chilled water to result in the final tofu pudding. If the pH of the mixture is too high or too low, the texture may change such that the final tofu pudding does not have the desired smooth and elastic texture.

In embodiments, the tofu pudding may have any desired fruit flavor, and a user may determine the flavoring depending on the type of fruit juice added.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for making fruit flavored tofu pudding, the method comprising:
mixing water, sugar, coagulants, a pH buffer agent, fruit juice, and optional natural flavorings and colorings in a preliminary mixture;
adding an appropriate amount of the pH buffer agent to have a pH of the preliminary mixture be slightly above the isoelectric point of soy protein;
adding soymilk to the preliminary mixture after a desired pH has been attained, creating a mixture; and
coagulating and pasteurizing the mixture by heating the mixture to a predetermined temperature, resulting in a fruit flavored tofu pudding having a smooth and elastic texture.

2. The method of claim 1, wherein the desired pH of the preliminary mixture is from about 5.0 to about 5.5.
